(19) United States
(12) Patent Application Publication
(10) Pub. No.: US 2025/0178861 A1
(43) Pub. Date: Jun. 5, 2025

(54) CONTROL OF A BUILDING SYSTEM

(71) Applicant: KONE Corporation, Helsinki (FI)

(72) Inventor: Markus Hautakorpi, Helsinki (FI)

(73) Assignee: KONE Corporation, Helsinki (FI)

(21) Appl. No.: 19/046,173

(22) Filed: Feb. 5, 2025

Related U.S. Application Data
(63) Continuation of application No. PCT/FI2022/050558, filed on Aug. 30, 2022.

(51) Int. Cl. B66B 1/34

(52) U.S. Cl. CPC B66B 1/3461; B66B 2201/40

(57) ABSTRACT

A method for controlling a building system is provided, the method, per-formed by a control system, comprises: determining a presence of a mobile robot in an operational vicinity area of the building system; and setting the building system to a robot mode in response to the determining the presence of the mobile robot in the operational vicinity area of the building system. Also a control system, a computer program, and a system are provided to.

### TECHNICAL FIELD

The invention concerns in general the technical field of building systems.

### BACKGROUND

The technical development in a variety of fields have enabled taking of giant leaps in a field of robotics. Currently the robots are harnessed to various tasks, and they are even capable of competing tasks autonomously, or at least semi-autonomously. Typical tasks for the robots arranged to move are delivery and picking up goods, but also different types of maintenance tasks, such as cleaning operations.

The increased capabilities of the robots have enabled their operations in the buildings and the like. The existing approach is that the robots operating in the building may be provided with an access to use building systems, such as doors, gates, and even elevators, through one or more application program interfaces (API) of the building systems. In other words, the manufacturers of the building systems develop the APIs and allow 3^{rd} parties, such as the robot manufacturers, to utilize the API to access the building systems to some extent. For example, through the APIs the robots may e.g. provide identification information, request service from one or more building systems, and so on.

Even if the application program interfaces are widely used and operable as such, they have their own drawbacks. First, it may turn out to be complex to utilize since they cannot be designed dedicated to each 3^{rd} party. On the other hand, there is no standard way of implementing the APIs. This may cause additional development work in the worst case at both sides. Also, since the APIs are always some kind of compromise, there may be challenges in maintaining security and privacy in a correct way. The APIs are also commonly considered slow in operation as well as expensive to develop.

Thus, there is a need to develop novel approaches in a field of the building systems to manage an operation of mobile robots in the buildings.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, a control system, a computer program, and a system for controlling a building system.

The objects of the invention are reached by a method, a control system, a computer program, and a system as defined by the respective independent claims.

According to a first aspect, a method for controlling a building system is provided, the method, performed by a control system, comprises:
determining a presence of a mobile robot in an operational vicinity area of the building system, and
setting the building system to a robot mode in response to the determining the presence of the mobile robot in the operational vicinity area of the building system.

The determining of the presence of the mobile robot in the operational vicinity area of the building system may comprise:
receiving monitoring data,
detecting the presence of the mobile robot in an operational vicinity area of the building system from the monitoring data.

The monitoring data may be received from a monitoring system configured to generate monitoring data for the control system.

For example, the detecting of the mobile robot may be performed based on analysis of at least one of the following type of monitoring data: image data; audio data; schedule data descriptive of events in a building the building system resides; data received over at least one radio channel.

Moreover, the setting of the building system to the robot mode may cause an adjustment of at least one technical feature of the building system applicable to use by the mobile robot. For example, the at least one technical feature may relate to at least one of the following operational parameter of the building system: a volume of an audio signal provided by the building system; appearance of data on at least one display of the building system; a provision of data for outputting to a plurality of dis-plays of the building system; lighting comfort of the building system; operating rate of at least one entity of the building system; operating accuracy of the building system; operating state of a monitoring device of the building system.

The method may further comprise, in response to a detection that the mobile robot (exits the operational vicinity area of the building system:
generating a control signal to the building system to cancel the robot mode of the building system.

The generating of the control signal to cancel the robot mode may also comprise a step of including data to the control signal to request the building system to return to a mode executed prior to setting the building system to the robot mode.

According to a second aspect, a control system for controlling a building system is provided, the control system is configured to:
determine a presence of a mobile robot in an operational vicinity area of the building system, and
set the building system to a robot mode in response to the determining the presence of the mobile robot in the operational vicinity area of the building system.

The control system may be configured to perform the determining of the presence of the mobile robot in the operational vicinity area of the building system by:
receiving monitoring data,
detecting the presence of the mobile robot in an operational vicinity area of the building system from the monitoring data.

The control system may be configured to receive the monitoring data from a monitoring system configured to generate monitoring data for the control system.

For example, the control system may be configured to detect the mobile robot based on analysis of at least one of the following type of monitoring data: image data; audio data; schedule data descriptive of events in a building the building system resides; data received over at least one radio channel.

Moreover, the control system may be configured to cause, in response to the setting of the building system to the robot mode, an adjustment of at least one technical feature of the building system applicable to use by the mobile robot. For example, the at least one technical feature relates to at least one of the following operational parameter of the building system: a volume of an audio signal provided by the building system; appearance of data on at least one display of the building system; a provision of data for outputting to a plurality of displays of the building system; lighting comfort of the building system; operating rate of at least one entity of the building system; operating accuracy of the building system; operating state of a monitoring device of the building system.

Also, the control system may further be configured to, in response to a detection that the mobile robot exits the operational vicinity area of the building system, to generate a control signal to the building system to cancel the robot mode of the building system. The control system may be configured to, in the generating of the control signal to cancel the robot mode, include data to the control signal to request the building system to return to a mode executed prior to setting the building system to the robot mode.

According to a third aspect, a computer program for controlling a building system is provided which computer program, when executed by a processor of the control system according to the second aspect as defined above, causes the control system to perform the method according to the first aspect as defined above.

According to a fourth aspect, a system is provided, the system comprising:
a control system according to the second aspect as defined above, and
at least one building system.

For example, the building system may be one of: an elevator, an escalator, an autowalk, an access control system, an automatic door, a gate, turnstiles, an access/ID reader, an infotainment solution, a charging system, a connectivity system.

In case the building system is an elevator, the setting of the robot mode may cause an activation of enhanced accessibility features of the elevator.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features.

The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of a system implementing the present invention.

FIG. 2 illustrates schematically an example of a mobile robot.

FIG. 3 illustrates schematically an example of a control system.

FIG. 4 illustrates schematically an example of a method.

FIGS. 5A and 5B illustrate schematically examples of aspects in relation to the present invention.

### DESCRIPTION OF THE EXEMPLIFYING EMBODIMENTS

The specific examples provided in the description given below should not be construed as limiting the scope and/or the applicability of the appended claims.

Lists and groups of examples provided in the description given below are not exhaustive unless otherwise explicitly stated.

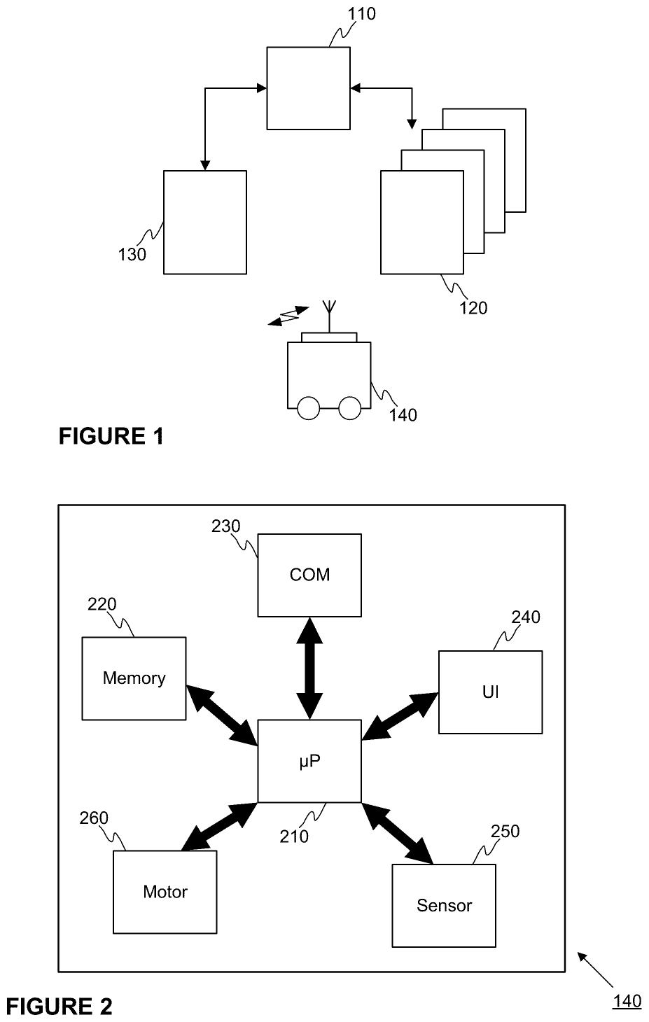

FIG. 1 illustrates schematically an example of a system into which the present invention may be implemented to. The system comprises a control system 110 which is configured to be communicatively connected to other entities of the system. The other entities may comprise one or more building systems 120 which refer to entities configured to implement a predefined function in the building. Such building systems may comprise, but are not limited to, doors, gates, and elevators in the building. The building may also be equipped with one or more monitoring systems 130 which are arranged to monitor at least an operational area of one or more building systems 130 and to generate monitoring data from the area they are configured to monitor. The communication connections between the mentioned entities may be implemented by utilizing known communication technologies implemented either in a wireless manner or in a wired manner. It may be arranged that the building systems 120 and the monitoring system(s) 130 are directly communicatively connected to the control system 110, but the communication of the system 120, 130 in question with the control system 110 may be arranged through other entities e.g. as a relay type of communication. It is also worthwhile to mention that the control system 110 may reside in the building or remotely to the building.

The building may provide an operational area for a number of mobile robots 140 which may operate in the building autonomously or semi-autonomously. This means that that the mobile robots 140 may travel in the building in accordance with their internal instructions to accomplish a task dedicated to them. For example, the mobile robot may receive its instructions from a robot management system (not shown in FIG. 1) and the mobile robot 140 itself is not communicatively connected to the systems, such as the building systems 120, in the building, not at least in a manner that it requires active connection setup with the mobile robot 140 and at least one of the building systems 120, the control system 110, or the monitoring system 130.

For sake of understanding aspects of the present invention it may be worthwhile to provide an example of a mobile robot suitable for operating in the building. An example of such a mobile robot 140 is shown in FIG. 2. The mobile robot 140 may comprise at least the following entities: a processing unit 210, a memory unit 220, a communication unit 230, a user interface (UI) unit 240, a sensor unit 250 and a motor unit 260. The mentioned entities may comprise one or more operating units, e.g. one or more microprocessors or similar, one or more memories, one or more communication devices, such as modems, one or more user interface devices, one or more sensors and one or more motors among other components of the respective entities if any. In addition to the mentioned entities the mobile robot 140 may comprise further devices and entities, such as batteries for storing energy to be used by the other entities. The entities belonging to the mobile robot 140 may be communicatively coupled to each other with e.g. a communication bus. The processing unit 210 may be configured to control the operation of the mobile robot 140 as well as a communication with external entities e.g. in a manner as described in the forthcoming description. The communication with the external entities, such as with a controller of the robot management system, may be performed e.g. in a wireless manner. The sensor unit 250 may comprise any sensors by means of which the mobile robot 110 may obtain information on an environment, but also the sensor unit 250 may comprise sensors enabling positioning and/or navigation within the location. This may refer to devices enabling a utilization of one or more indoor positioning systems, e.g. those implemented in the building if any. The processing unit 210 may also be configured to generate control signals to the motor unit 260 in order to make the mobile robot 140 to move. Moreover, the mobile robot 140 may comprise means enabling the robot to be mobile, such as any applicable transport means like wheels with other required elements and devices. The operation of the processing unit 210 may be achieved by executing portions of computer program code stored e.g. in the memory unit 220 for generating the control signals and, thus, causing the mobile robot 140 to operate in the manner as described. The memory unit 220 may also be used for storing obtained and received information together with any other data either permanently or temporarily.

For sake of clarity the building systems 120 in accordance with the present invention are such that they need to be utilized, such as accessed, by the mobile robot 140 when accomplishing a task assigned to it in the building. Such building systems 120 may e.g. be different kinds of conveyor systems (e.g. elevators, escalators, and autowalks), access solutions (e.g. access control, automatic doors, gates, turnstiles, access/ID readers), infotainment solutions (e.g. infoscreens), charging solutions, connectivity solutions, and any similar implemented in the building.

As is clear the building may be equipped with other devices, such as user interface devices, like displays, keyboards, and audio devices, by means of which it is possible to output, but also to receive, information to and from individuals roaming in the building. At least some of them may belong to one of the described systems, such as to the building systems 120.

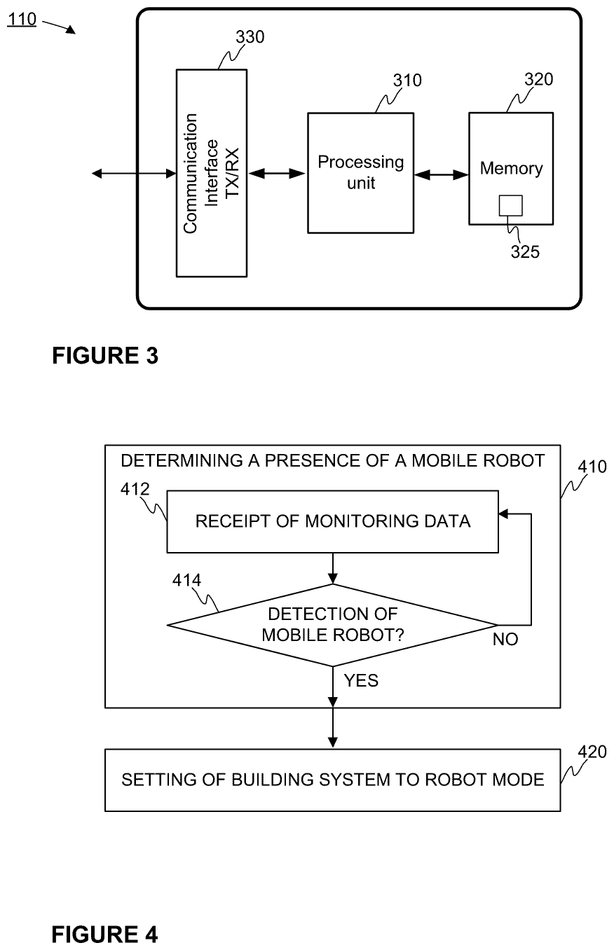

FIG. 3 illustrates an example of an apparatus suitable for operating in a role of a control system 110. However, the functionality of the control system 110 may also be integrated to another computing device or arranged as a distributed computing environment with a plurality of apparatuses as shown in FIG. 3. The control system 110 may be configured to perform a method according to the invention as is described in the forthcoming description. In other words, the apparatus of FIG. 3 may be configured to perform a function to control the building system. For sake of clarity, it is worthwhile to mention that the block diagram of FIG. 3 depicts some components of an entity that may be employed to implement a functionality of the apparatus. The apparatus of FIG. 3 comprises a processor 310 and a memory 320. The memory 320 may store data, such as pieces of data as described, but also computer program code 325 causing the controlling of the building system in the manner as is described. The apparatus may further comprise a communication interface 330, such as a wireless communication interface or a communication interface for wired communication, or both to communicate with other entities as described. The communication interface 330 may thus comprise one or more modems, antennas, and any other hardware and software for enabling an execution of the communication e.g. under control of the processor 310. Furthermore, I/O (input/output) components may be arranged, together with the processor 310 and a portion of the computer program code 325, to provide a user interface for receiving input from a user, such as from a technician, and/or providing output to the user of the apparatus when necessary. In particular, the user I/O components may include user input means, such as one or more keys or buttons, a keyboard, a touchscreen, or a touchpad, etc. The user I/O components may include output means, such as a loudspeaker, a display, or a touchscreen. The components of the apparatus may be communicatively connected to each other via data bus that enables transfer of data and control information between the components.

The memory 320 and at least a portion of the computer program code 325 stored therein may further be arranged, with the processor 310, to cause the apparatus to perform at least a portion of a method as is described in the following description. The processor 310 may be configured to read from and write to the memory 320. Although the processor 310 is depicted as a respective single component, it may be implemented as respective one or more separate processing components. Similarly, although the memory 320 is depicted as a respective single component, it may be implemented as respective one or more separate components, some, or all of which may be integrated/removable and/or may provide permanent/semi-permanent/dynamic/cached storage.

The computer program code 325 may comprise computer-executable instructions that implement functions that correspond to steps implemented in the method when loaded into the processor 310 of the respective control system 110. As an example, the computer program code 325 may include a computer program consisting of one or more sequences of one or more instructions. The processor 310 is able to load and execute the computer program by reading the one or more sequences of one or more instructions included therein from the memory 320. The one or more sequences of one or more instructions may be configured to, when executed by the processor 310, cause the apparatus to perform a method as described. Hence, the apparatus may comprise at least one processor 310 and at least one memory 320 including the computer program code 325 for one or more programs, the at least one memory 320 and the computer program code 325 configured to, with the at least one processor 310, cause the apparatus implementing the control system 110 to perform the method.

The computer program code 325 may be provided e.g. a computer program product comprising at least one computer-readable non-transitory medium having the computer program code 325 stored thereon, which computer program code 325, when executed by the processor 310 causes the apparatus to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code 325 may comprise a proprietary application, such as computer program code for causing an execution of the method in the manner as described in the description herein.

Any of the programmed functions mentioned may also be performed in firmware or hardware adapted to or programmed to perform the necessary tasks.

For sake of completeness it is repeated here that the entity performing the method in the role of the control system 110 may also be implemented with a plurality of apparatuses, such as the one schematically illustrated in FIG. 3, as a distributed computing environment corresponding to a control system 110. For example, one of the apparatuses may be communicatively connected with the other apparatuses, and e.g. share the data of the method, to cause another apparatus to perform at least one other portion of the method. As a result, the method performed in the distributed computing environment enables the controlling in accordance with the present invention, and also to perform further steps as is described herein.

An example of a method for controlling a building system in accordance with an embodiment of the invention is schematically illustrated in FIG. 4. The method may be performed by a control system 110 as described in the foregoing description.

The method may comprise a first step in which a presence of a mobile robot 140 is determined 410 and a second step wherein a building system 120 is set 420 to a robot mode. The determination 410 of the presence of the mobile robot 140 refers to a determination if the mobile robot 140 is in an operational vicinity area of a building system 120. In other words, in step 410 it is determined 410 if there is at least one mobile robot 140 in such a location with respect to the building system 120, i.e. in an operational vicinity area of the building system 120, that there is a need to set the building system 120 to the robot mode. Such robot mode enhances a capability of the building system 120 to serve the mobile robot 120. The setting 420 of the robot mode by the control system 110 may be performed by generating a control signal including data causing the setting of the robot mode in the respective building system 120 being a recipient, either directly or indirectly, of the generated control signal. The control signal may also be configured to carry data descriptive of operations to be carried out by the respective building system 120, such as adjusting one or more technical parameters of the building system 120 in a certain way.

The step of determining 410 the presence of the mobile robot 140 may comprise some sub-steps. For example, in step 412 a monitoring data may be received. The monitoring data may be received from a monitoring system 130. The monitoring data may be received in a continuous manner, e.g. at predefined intervals, and/or it may be triggered upon a predefined event. In some example embodiments, such a predefined event may be a signal received from a building system 120. For example, the signal may carry data by means of which the building system 120 may be identified and its location may be determined e.g. directly based on the received data or it may be inquired from a data storage arranged to store data linking the location data with the building system 120. Alternatively or in addition, the data storage may store data identifying directly a monitoring system 130 arranged to monitor the building system 120 in question. Upon determining the monitoring system 130 it may be triggered to provide monitoring data in relation to the building system 120 in question.

As is clear the monitoring data varies in accordance with the selected monitoring system 130. An advantageous monitoring system 130 for the task in accordance with the present invention may be an applicable imaging system. For example, the imaging system may be a system comprising a number of image capturing devices arranged to capture images at predefined intervals from a predefined area of a monitored building system 120, but sensors may also be any other devices, such as radars (radio detection and ranging), lidars (light detection and ranging), ToF (Time of Flight) sensor, or any similar devices based on applicable electromagnetic radiation. The predefined area, or space, of the monitored building system 120 may e.g. refer to an operational vicinity area of an entity belonging to the monitored building system 120, such as a gate or a door of the building system 120 managing access devices in the building, or it may be a waiting area of an elevator at a floor wherein the building system 120 is the elevator. Another applicable monitoring system 130 for the task may be a system based on audio signal monitoring in an operational area of the respective building system 120. It may be implemented e.g. so that one or more microphones are installed in locations allowing capturing of audio data from a predefined area of the building system 120 e.g. correspondingly to the description provided above in relation to the monitoring system 120 based on image capturing devices. In addition to the above mentioned monitoring systems 130 the monitoring may be based on monitoring one or more radio channels in the predefined area in a passive way e.g. so that it may be detected if a predefined object enters the predefined area. For example, the predefined object may carry a radio transmitter configured to send a predefined signal at a predefined signal, such as a beacon signal, a presence of such a signal in the predefined area may be detected by means of applicable sensors, such as a radio channel scanner or a radio receiver arranged to monitor one or more predefined radio channels in an operational vicinity area of the building system 120 in question. Moreover, in some example embodiments the monitoring data may be a scheduling data descriptive of events in a building the building system resides. A non-limiting example of such scheduling data may e.g. be data defining e.g. a route of a mobile robot 140 at a necessary accuracy so as to enable the control system 110 to define an instant of time the mobile robot 140 shall reside at an operational vicinity area of the building system 120 controllable by the control system 110. Such data the control system 110 may receive from an external system also considered as a monitoring system wherein the external system may e.g. be a mobile robot management system, a scheduling system (e.g. maintaining calendar data), or similar. The data may e.g. be delivered to the control system 110 as notifications, alerts, or in any other form of messages wherein such data is included that allows the control system 110 to determine a presence of the mobile robot 140 at least in an operational vicinity area with respect to the building system 120 in question. To summarize the above given description it may be said that the control system 110 receives 412 monitoring data of a predefined type from the monitoring system 130 and is configured to perform further steps as is described in the forthcoming description.

The control system 110 may be configured to analyze the received monitoring data in a predefined manner and the analysis may at least be configured to generate a detection 414 if a mobile robot 140 is present in an operational vicinity area of the building system 120 in question or not as a second sub-step to the determining 410 step. In other words, the control system 110 may be configured to compare received monitoring data to reference data and generate an indication based on an outcome of the comparison. Such comparison step shall be understood to cover any classification tasks arranged to be implemented with a trained machine-learning model for the task. The classification may generate an indication of a detection of the mobile robot 140 based on the received monitoring data by classifying the monitoring data to belong to a class corresponding a class indicative of a presence of a mobile robot 140. In case the monitoring data corresponds to image data captured from a predefined area the control system 110 may be configured to execute a computer program causing an application of a pattern recognition algorithm to the image data to detect a presence of a mobile robot 140 in the image data in any known manner. In case the monitoring data is audio data obtained from the predefined area the control system 110 may be arranged to detect audio data from the monitoring data which represents sound generated by a mobile robot 140. In some example embodiments, the mobile robots 140 may be arranged to output a predefined sound and/or sound pattern e.g. when moving in the building and the control system 110 may be configured to detect the respective data from the audio data captured from the predefined area. Correspondingly, if the monitoring and the detection 414 of the mobile robot is based on radio signals detected in the predefined area, or space, a detection indicative of the presence of the mobile robot 140 may be performed. Generally speaking, any criteria in order to perform the detection of the mobile robot 140, if any, shall be defined in accordance with the applied monitoring system 130 and it is possible to arrange a plurality of different types of sensors to detect the presence of the mobile robot 140 in the predefined area, such as image capturing devices allowing pattern recognition together with audio based sensors. Moreover, in case the received monitoring data is some sort of scheduling data or anything similar, the detection may be based on analysis of such data and e.g. to a comparison of the location of mobile robot 140 to a location of the operational vicinity area of one or more building systems 120 at various instants of time, for example.

For sake of clarity it is worthwhile to mention that if the analysis does not generate a detection of the mobile robot in the sub-step 414, and in the determining step 410 in general, the monitoring may be continued in a manner that the control system 110 keeps receiving 412 and analyzing the monitoring data. On the other hand, if the sub-step 414, and thus the determining step 410 in general, generates a detection on the mobile robot 140, the control system 110 may set a detection result to indicate a presence of the mobile robot 140 in the operational vicinity area of the building system 120 in question based on the monitoring data. The detection result indicating the presence of the mobile robot 140 causes setting 420 of the respective building system 120 to a robot mode e.g. by generating a control signal including data causing the setting of the robot mode. In accordance with some embodiment it is possible to arrange that the detection result may also be set to indicate a non-presence of the mobile robot 140 based on the monitoring data which e.g. maintains the mode of the building system 120 as is. For sake of clarity it is worthwhile to mention that the detection result to indicate the presence of the mobile robot 140 may be generated if a predefined confidence level, or a reference level, is exceeded based on analysis of the monitoring data. In other words, the control system 110 is not necessarily required to generate the detection only with full accuracy, i.e. 100%, but it may be set so that if a probability of the presence of the mobile robot 140 in the area exceeds the predefined confidence level, e.g. 75%, the indication on the presence may be generated. The above mentioned confidence levels are non-limiting examples and may be defined based on a required accuracy of the system.

In accordance with the present invention the setting 420 of a building system 120 to a robot mode refers to a mode defined for the respective building system 120 in which mode an operational aspects required by the mobile robot 140 is at least in part taken into account. In other words, the setting 420 of the building system 120 to the robot mode may cause an adjustment of at least one technical feature of the building system 120 optimal to use by the mobile robot 140. This serves the mobile robot 140 autonomously operating in the building to succeed in its task. For example, the at least one technical feature adjustable by the control system 110 may relate to at least one of the following operational parameter of the building system 120 under control:
a management of an audio signal provided by the building system 120 (e.g. volume of an audio signal output in an elevator car to indicate a floor enabling the mobile robot 140 to receive the information; triggering of an output of a specific audio signal by an elevator system to indicate a presence of an elevator car at a floor (e.g. with doors open));
appearance of data on at least one display of the building system 120 (e.g. a font size and/or a contrast of a display of e.g. an elevator car/a gate/a door/a lobby enabling the mobile robot 140 to receive the information);
a provision of data for outputting to a plurality of displays of the building system 120 (e.g. provision of the data in multiple displays of an elevator car enabling the mobile robot 140 to receive the information);
lighting comfort of the building system 120 (e.g. adjustment of light in an elevator car 140 for improving the capability of the mobile robot 140 to sense environment);
operating rate of at least one entity of the building system 120 (e.g. adjustment of opening/closing times of elevator doors, access doors and/or access gates allowing the mobile robot 110 enough time to access the respective access entity; adjustment of time for providing input through a user interface, such as a car operating panel in an elevator; adjustment of time for initiating a requested service, such as issue a travel call to an elevator; adjustment of motion of an elevator car, such as speed and/or acceleration/deceleration);
operating accuracy of the building system 120 (e.g. require an elevator car to land accurately to a floor level to avoid tripping or trapping of the mobile robot at the doorstep)
activate an operating state of a monitoring device of the building system 120 (e.g. activate a camera in an elevator car or at a gate/door is switched on to allow monitoring of the mobile robot 140)
generating a signal carrying information on the detected mobile robot to a party, such as to a building manager, for further use (e.g. the party may initiate a monitoring of the mobile robot 140 in the building/progress on the task, and even provide support remotely or by visiting a site the mobile robot 140 resides).

As derivable from the non-limiting examples above the control system 110 may be configured to adjust a wide range of operational features, or characteristics, in response to a detection that a mobile robot 140 is requiring service from the respective building system 120.

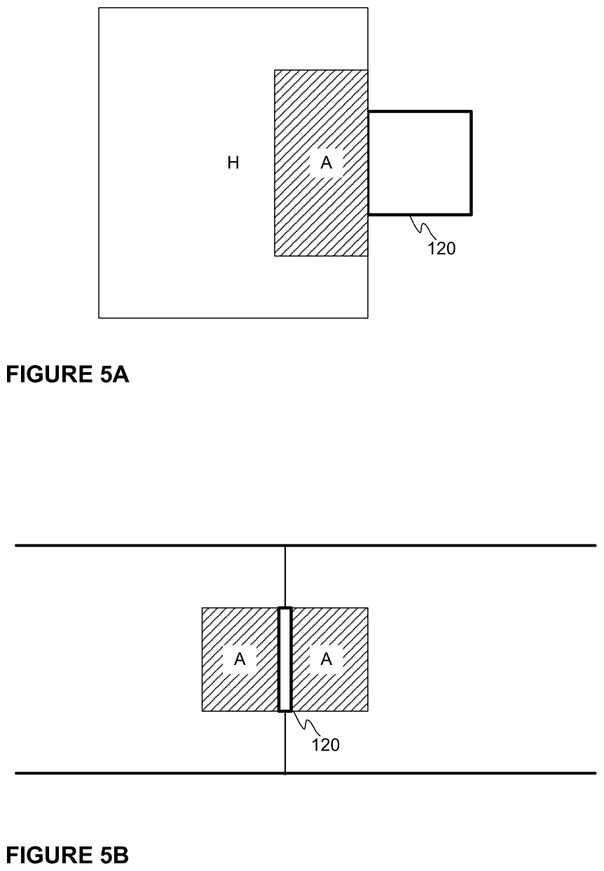

For sake of completeness, the used term operational vicinity area of the building system 120 shall be understood as an area, or a space, at a predefined location with respect to the respective building system 120 wherein a mobile robot 140 may reside when it intends, or is willing, to use the respective building system 120. Such areas, or spaces, are definable in a building system 120 by building system 120 manner. FIGS. 5A and 5B provide some non-limiting examples of such areas in different context. In FIG. 5A the building system 120 may be an elevator and FIG. 5A illustrates schematically a hall H visualized from above the respective hall H area. The visitors of the building may roam in the hall area, and a predefined sub-area marked with ‘A’ in FIG. 5A may be defined as an area in which one or more mobile robots 140 may reside when it/they require service from the elevator. Thus, the respective area A may be considered to correspond to the term operational vicinity area of the building system 120 in case of the elevator, and the monitoring system 130, such as at least one camera of the monitoring system 130 or at least one microphone may be arranged to obtain information at least from the area A. At least he analysis of the monitoring data is to be performed for the area A defining the operational vicinity area of the building system 120. Moreover, FIG. 5B provides another example of the area A defining the operational vicinity area of the building system 130 being a gate or a door accessible by the mobile robot 140. The operational vicinity area according to the example as shown in FIG. 5B extends over the respective building system 120 which allows monitoring of a presence of mobile robots 140 at both sides of the building system 120 being a gate or a door, for example. This kind of arrangement also allows to monitor a progress of the use of the respective building system 120 by the mobile robot 140, e.g. when the mobile robot 140 in question passes the building system 120.

As already discussed, in case the building system 120 into which the present invention is applied to is the elevator system as mentioned herein the robot mode into which the elevator system is set may cause an adjustment of so-called accessibility features of the elevator. These may correspond to extended operating times of entities belonging to the elevator, such as opening and closing times of the elevator doors, duration of a receipt of input from the mobile robot 140, speed and/or acceleration/deceleration of the elevator car, and so on as already mentioned.

Some aspects of the invention may relate to an arrangement in which the monitoring system 130 is arranged to generate data by means of which it is possible to determine a progress in relation to a use of the building system 120 by the mobile robot 140. In other words, the monitoring system 130 may be configured to continue gathering monitoring data and the control system 110, respectively, continues to analyze the progress by evaluating a location of the mobile robot 140 with respect to the building system 120. For example, it may be arranged that the control system 110 is configured to detect, based on the monitoring data, if the mobile robot 140 enters an elevator car residing at the landing or not. In response to a determination that the mobile robot 140 entered the elevator car it may be generated an indication, or a detection result, to indicate that the building system 120 in question is used by the mobile robot 140. Correspondingly, in case the building system 120 is an access gate or an access door it may be determined from the monitoring data if the mobile robot 140 passes by the respective building system 120. This may be arranged by gathering the monitoring data at both sides of the building system 120, e.g. as shown in FIG. 5B, and in response to a detection that the mobile robot 140 moves from one side to another, it may be concluded that the mobile robot 140 has used the building system 120. A respective detection result may be generated. The applied analysis mechanisms to evaluate the progress of the use of the building system 120 may be based on the same kind of analysis as described in the foregoing description with respect to detect the mobile robot 140 in the operational vicinity area of the building system 120. For example, the analysis may be based on pattern recognition from the image data or audio signals obtained at optimal locations with respect to the building system 120.

In accordance with some example embodiments of the present invention the generation of the indication, or the detection result, indicating that the mobile robot has used the building system may correspond to a detection that the mobile robot 140 has exited the operational vicinity area of the building system 120 and as a result the robot mode set for the building system 120 may be canceled by the control system 110 with a control signal. For example, the control system 110 may be configured to generate a control signal e.g. to the respective building system 120 causing returning the building system 120 to a mode, such as a normal mode, the building system 120 was executing prior to the setting of the robot mode. In other words, the control signal may comprise data indicating the request to return to the mode executed prior to setting to the robot mode. The data may e.g. be descriptive of the requested mode to be returned.

The term ‘building’ used in the description of the invention herein shall be understood in a broad manner and covers any types of structures and/or spaces comprising such building systems 120 into which the present invention may be implemented to. Typical non-limiting examples of such structures may e.g. be multi-storey houses, ships, factory buildings, transportation buildings (e.g. underground stations), public places (e.g. marketplaces and streets), and the like.

The specific examples provided in the description given above should not be construed as limiting the applicability and/or the interpretation of the appended claims. Lists and groups of examples provided in the description given above are not exhaustive unless otherwise explicitly stated.

1. A method for controlling a building system, the method, performed by a control system, comprises:
determining a presence of a mobile robot in an operational vicinity area of the building system, and
setting the building system to a robot mode in response to the determining the presence of the mobile robot in the operational vicinity area of the building system.

2. The method according to claim 1, wherein the determining of the presence of the mobile robot in the operational vicinity area of the building system comprises:
receiving monitoring data,
detecting the presence of the mobile robot in an operational vicinity area of the building system from the monitoring data.

3. The method according to claim 2, wherein the monitoring data is received from a monitoring system configured to generate monitoring data for the control system.

4. The method according to claim 2, wherein the detecting of the mobile robot is performed based on analysis of at least one of the following type of monitoring data: image data; audio data; schedule data descriptive of events in a building the building system resides; data received over at least one radio channel.

5. The method according to claim 1, wherein the setting of the building system to the robot mode causes an adjustment of at least one technical feature of the building system applicable to use by the mobile robot.

6. The method according to claim 5, wherein the at least one technical feature relates to at least one of the following operational parameter of the building system: a volume of an audio signal provided by the building system; appearance of data on at least one display of the building system; a provision of data for outputting to a plurality of displays of the building system; lighting comfort of the building system; operating rate of at least one entity of the building system; operating accuracy of the building system; operating state of a monitoring device of the building system.

7. The method according to claim 1, the method further comprises, in response to a detection that the mobile robot exits the operational vicinity area of the building system:
generating a control signal to the building system to cancel the robot mode of the building system.

8. The method according to claim 7, wherein the generating of the control signal to cancel the robot mode comprises a step of including data to the control signal to request the building system to return to a mode executed prior to setting the building system to the robot mode.

9. A control system for controlling a building system, the control system is configured to:
determine a presence of a mobile robot in an operational vicinity area of the building system, and
set the building system to a robot mode in response to the determining the presence of the mobile robot in the operational vicinity area of the building system.

10. The control system according to claim 9, wherein the control system is configured to perform the determining of the presence of the mobile robot in the operational vicinity area of the building system by:
receiving monitoring data,
detecting the presence of the mobile robot in an operational vicinity area of the building system from the monitoring data.

11. The control system according to claim 10, wherein the control system is configured to receive the monitoring data from a monitoring system configured to generate monitoring data for the control system.

12. The control system according to claim 10, wherein the control system is configured to detect the mobile robot based on analysis of at least one of the following type of monitoring data: image data; audio data; schedule data descriptive of events in a building the building system resides; data received over at least one radio channel.

13. The control system according to claim 9, wherein the control system is configured to cause, in response to the setting of the building system to the robot mode, an adjustment of at least one technical feature of the building system applicable to use by the mobile robot.

14. The control system according to claim 13, wherein the at least one technical feature relates to at least one of the following operational parameter of the building system: a volume of an audio signal provided by the building system; appearance of data on at least one display of the building system; a provision of data for outputting to a plurality of displays of the building system; lighting comfort of the building system; operating rate of at least one entity of the building system; operating accuracy of the building system; operating state of a monitoring device of the building system.

15. The control system according to claim 9, the control system is further configured to, in response to a detection that the mobile robot exits the operational vicinity area of the building system, to generate a control signal to the building system to cancel the robot mode of the building system.

16. The control system according to claim 15, wherein the control system is configured to, in the generating of the control signal to cancel the robot mode, include data to the control signal to request the building system to return to a mode executed prior to setting the building system to the robot mode.

17. A non-transitory computer readable medium storing a computer program for controlling a building system which, when executed by a processor of a control system, causes the control system to perform the method according to claim 1.

18. A system comprising:
a control system according to claim 9, and
at least one building system.

19. The system of claim 18, wherein the building system is one of: an elevator, an escalator, an autowalk, an access control system, an automatic door, a gate, turnstiles, an access/ID reader, an infotainment solution, a charging system, a connectivity system.

20. The system according to claim 18, wherein, when the building system is an elevator, the setting of the robot mode causes an activation of enhanced accessibility features of the elevator.
